(19) United States
(12) Patent Application Publication
(10) Pub. No.: US 2008/0191373 A1
(43) Pub. Date: Aug. 14, 2008

(54) Method of regenerating molding die for use in molding porous structure body

(75) Inventor: Hitoshi Kanmura, Mie-ken (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/068,346

(22) Filed: Feb. 5, 2008

(30) Foreign Application Priority Data
Feb. 13, 2007 (JP) 2007-032166

(51) Int. Cl. B28B 7/00

(52) U.S. Cl. 264/39

(57) ABSTRACT

In a method of regenerating a molding die which is over its lifetime after repetition use, a slit groove part, namely, an upper end surface of each block body in the molding die is cut or grinded to obtain a flat upper end surface of each block body. After completion of the cutting step, the flat upper end surface of each block body is coated with a coating layer using CVD method or a combination of CVD and PVD methods. Those steps enable each slit groove to have an original opening width, like each slit groove in a new molding die before repetition use. After completion of the regeneration, the regenerated molding die can produce porous structure bodies by extruding clayey ceramic raw material through the slit grooves.

### CROSS-REFERENCE TO RELATED APPLICATION

This application is related to and claims priority from Japanese Patent Application No. 2007-32166 filed on Feb. 13, 2007, the contents of which are hereby incorporated by reference.

### BACKGROUND OF THE INVENTION

1. Field of the Invention

The present invention relates to a method of regenerating a molding die after repetition use of extruding porous structure bodies (or mold bodies).

2. Description of the Related Art

Recently, it has been known that repetition use of a mouthpiece member, namely, a molding die in order to produce (extrude and mold) porous structure bodies using clayey ceramic raw material, results the worn of the mouthpiece member. In particular, an opening width of each slit groove (or a slit groove width) formed in a slit groove formation surface of the mouthpiece member becomes increased after repetition use because the clayey ceramic raw material is extruded through the slit grooves and a base metal forming the mouthpiece member (namely, the molding die) is thereby worn.

In order to prevent the wearing of the molding die in repetition use, a related art technique has proposed a method of coating a new mouthpiece member (before repetition use) with an evaporated film of a uniform thickness by chemical vapor deposition (CVD). For example, Japanese patent laid open publication No. JP H5-269719 disclosed such a related art technique.

The technique JP H5-269719 uses a vapor deposition apparatus which is comprised of a cylindrical vacuum chamber, a heater disposed at the outside of the chamber, a setter placed in the chamber, and a gas exhaust room formed between the chamber and the setter, and a source gas supply pipe disposed at a middle part of a reaction chamber where a chemical vapor deposition (CVD) is carried out.

The mouthpiece member (or the molding die) is coated with an evaporated film using such a chemical vapor deposition (CVD) apparatus.

First, a plurality of mouthpiece members is prepared, and placed in a CVD room (as the reaction chamber) in the CVD apparatus so that the slit groove formation surface of each mouthpiece member through which a clayey raw material is extruded faces a source gas supply pipe side in the CVD apparatus.

Following, the source gas is blown onto the slit groove formation surface of each mouthpiece member from a plurality of source gas injection outlets of the CVD apparatus while the source gas supply pipe rotates. At this time, a vacuum pump sucks the gas in the gas exhaust room in the CVD apparatus in order to flow a large part of the source gas from the source gas injection outlets toward the slit groove formation surface of each mouthpiece member. The source gas is thereby exhausted to the gas exhaust room through a circular-shaped exhaust outlet formed in a side peripheral wall of the vacuum chamber of a cylindrical shape in the CVD chamber. The slit groove formation surface of each mouthpiece member is coated with an evaporated film as a coating layer.

Because the slit groove formation surface of the mouthpiece member is covered with the coating layer, it is possible to improve and increase a wear resistance and to have a long lifetime of each mouthpiece member when compared with a mouthpiece member without having such a coating film.

The mouthpiece member covered with the coating layer is repeatedly used many times in order to extrude and mold porous structure bodies. The above repetition use gradually wear the slit groove formation surface of the mouthpiece member (or the molding die). After the repetition use, the slit groove width of the mouthpiece member exceeds its predetermined allowable slit groove width. Such a mouthpiece member having an expanded slit groove width cannot act as the molding die, and an operator must replace the mouthpiece member with a new one with an evaporated film formed on the slit groove formation surface, which must be produced by the above manner.

Since it is preferable to make the mouthpiece member using a high wear resistance (acts as the molding die), the material cost of the mouthpiece member becomes expensive as well as a production cost of making the plural slit groove in the base material of the mouthpiece member. This results the production cost of the porous structure bodies because of using the expensive mouthpiece member. In consideration of the related art problem described above, it may be said that regenerating a mouthpiece member (or a molding die) over its lifetime can decrease the production cost of the porous structure bodies.

### SUMMARY OF THE INVENTION

It is an object of the present invention to provide a method of regenerating a mouthpiece member (or a molding die) for use in producing porous structure bodies.

To achieve the above purpose, the present invention provides a method of regenerating a molding die, which is over its lifetime, for use of producing porous structure bodies. The method according to the present invention has a step of cutting an upper end surface of each block body forming the molding die by a predetermined constant depth. The molding die has a plurality of block bodies with which a plurality of slit grooves is formed in a predetermined arrangement. The predetermined constant depth is measured from the upper end surface of each block body toward the corresponding circular hole. Each circular hole communicates with the corresponding slit groove. The cutting step can regenerate a slit groove width (or an opening width of each slit groove) in the molding die over its lifetime. That is, the opening width of each slit groove is repaired in its original opening width in a new molding die before repetition use. The cutting step enables a corner part, which is formed between a side surface of and the upper end surface of each block body to have an original acute angle. The molding die regenerated by the method according to the present invention can be used again in repetition use for producing porous structure bodies.

In the method as another aspect of the present invention, the upper end surface of each block body in the molding die over its lifetime is cut by at least one of a grinding method, an electric discharge method, and an acid treatment method. In the cutting step, the predetermined constant depth is within a range from at least not less than 0.1 mm to not more than 10% of a slit groove depth, wherein the slit groove depth is defined as a value measured from the upper end surface of each block body to a joint part at which the slit groove communicates with the corresponding circular hole. The reason why the lower limit of the cutting depth is 0.1 mm is that it is impossible to repair the corner angle, which is formed between the upper end surface and the side surface of each block body in a desired acute angle when the cutting depth is less than 0.1 mm. Further, the reason why the upper limit of the cutting depth is not more than 10% of the slit groove depth is to avoid deteriorating or decreasing the strength of each block body forming the molding die. Thus, the method according to the present invention limits the cutting length in the slit groove depth for each block body.

In the method as another aspect of the present invention, a coating layer is formed on at least the upper end surface of each block body after completion of the cutting step, wherein the coating layer is harder than the base material forming the block bodies. The formation of the coating layer can increase the wear resistance capability of the molding die. The formation of the coating layer can extend the lifetime of the molding die at least not less than two times, as shown in FIG. 9.

In the method as another aspect of the present invention, during the coating layer forming step, the circular hole part is covered with a masking plate in order to form the coating layer only on the slit groove part, namely, on the upper end surface of each block body. Using the masking plate offers uniform supply of a reaction gas flow onto the slit groove part of the molding die. This enables the coating layer to be uniformly formed on the slit groove part, namely, on the upper end surface of each block body of the molding die.

In the method as another aspect of the present invention, the coating layer is composed of a plurality of coating layers. It is also possible to form a single coating layer on the upper end surface of the block body.

In the method as another aspect of the present invention, when the molding die over its lifetime as a target of the regeneration has the coating layer formed on the upper end surface of each block body (or on the slit groove part), the cutting step cuts the remained coating layer in addition to the upper end surface of each block body. That is, the molding die over its lifetime has two types, one type without any coating layer and the other type with the coating layer remained in its base material forming the molding die. Thus, even if the coating layer is remained on the base material forming the molding die, the method according to the present invention can repair the corner part, which is formed between the side surface and the upper end surface of each block body in an acute angle shape.

### BRIEF DESCRIPTION OF THE DRAWINGS

A preferred, non-limiting embodiment of the present invention will be described by way of example with reference to the accompanying drawings, in which:

FIG. 1A is a cross section of a molding die, for use in producing porous structure bodies, which is regenerated by the method according to the present invention;

FIG. 1B is a partial enlarged perspective view of the molding die shown in FIG. 1A;

FIG. 1C is a cross section of a block body forming slit grooves in the molding die shown in FIG. 1A;

FIG. 2 is a cross section of adjacent block bodies in the molding die over its lifetime;

FIG. 3 is a view showing a relationship between a slit groove width and a ratio of a slit groove depth measured from a slit groove upper part to a slit groove bottom part in two types of molding dies, a new molding die and a molding die over its life time;

FIG. 4A is a schematic view of a configuration of a CVD apparatus, used by the method according to the first embodiment of the present invention, with which a coating layer is formed on the molding die;

FIG. 4B is an enlarged view showing the molding die over its lifetime which is placed on a set table in the CVD apparatus shown in FIG. 4A;

FIG. 5 is a cross section of the block body forming the molding die, for use in producing porous structure bodies, which is regenerated by the method according to a second embodiment of the present invention;

FIG. 6A is a schematic view of a configuration of a PVD apparatus, used by the method according to the second embodiment of the present invention, with which first and second coating layers are formed in each block body of the molding die;

FIG. 6B is an enlarged view showing the molding die over its lifetime placed on a rotary table in the PVD apparatus shown in FIG. 6A;

FIG. 7A is an explanatory view of defining a coating layer thickness measured from a slit groove side surface and of defining a slit groove depth measured from a slit groove upper part of the molding die;

FIG. 7B is a comparison result of different treatments (CVD and CVD+PVD) in a relationship between the coating layer thickness and the slit groove depth in the molding die;

FIG. 8A is an explanatory view of defining a coating layer thickness measured from a block body upper part and a distance measured from a slit groove side surface in the molding die;

FIG. 8B is a comparison result of different treatments (CVD and CVD+PVD) in a relationship between the coating layer thickness and the distance measured from the slit groove side surface shown in FIG. 8A.

FIG. 9 is a comparison result in lifetime of various types of molding dies, not processed, processed using PVD method, processed using CVD method, and processed using a combination of CVD and PVD methods;

FIG. 10A is a view showing the molding die over its lifetime, having circular holes (or feed holes) covered with a masking plate, placed on the setting jig on the set table in the CVD apparatus; and

FIG. 10B is a view showing the molding die over its lifetime, having the circular holes covered with the masking plate, placed on the setting jig on the rotary table in the PVD apparatus

### DETAILED DESCRIPTION OF THE PREFERRED EMBODIMENTS

Hereinafter, various embodiments of a method of regenerating a mouthpiece member (or a molding die) according to the present invention will be described with reference to the accompanying drawings. In the following description of the various embodiments, like reference characters or numerals designate like or equivalent component parts throughout the several diagrams.

### First Embodiment

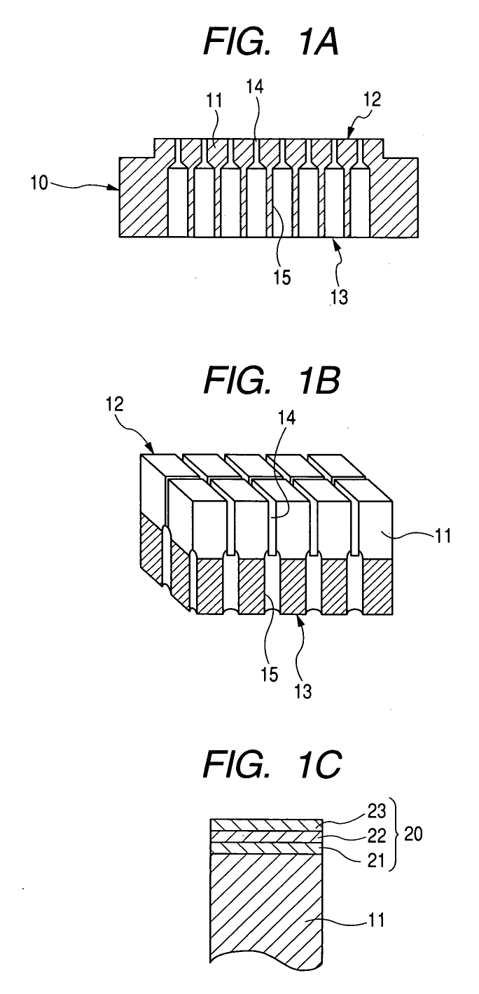

A description will be given of the method of regenerating a mouthpiece member (or a molding die) according to a first embodiment of the present invention with reference to FIGS. 1A, 1B and 1C to FIGS. 4A and 4B.

The first embodiment describes the method of regenerating a molding die for use in producing mold bodies such as porous structure bodies by extruding clayey ceramic raw material obtained by mixing ceramic raw material powder with water. The extruded or molded porous structure body is then fired in order to produce porous structure bodies such as a monolith structure body and an exhaust gas purifying filter (or a Diesel Particulate Filter DPF)) capable of purifying particulate matters contained in an exhaust gas emitted from an internal combustion engine of a vehicle.

FIG. 1A is a cross section of a molding die 10 after completion of the regeneration by the method according to the present invention. The molding die 10 is used in producing porous structure bodies. FIG. 1B is a partial enlarged perspective view of the molding die 10 shown in FIG. 1A. FIG. 1C is a cross section of one block body 11 forming slit grooves 14 in the molding die 10 regenerated, as shown in FIG. 1A.

The molding die 10 is a plate member for use in producing mold bodies having a porous structure. The molding die 10 is made by working a metal plate. For example, JIS (Japanese Industrial standard) SKD 61 having a hardness of approximating 500 HV (as die steel or alloy tool steel) can be used as a metal plate. The molding die 10 reaches its lifetime after repetition use. The molding die 10 shown in FIG. 1A is made by regenerating the molding die which is over its lifetime after repetition use. The molding die 10 has a slit groove part 12 having a plurality of slit grooves 14 formed on one surface side and a circular hole part 13 having a plurality of circular holes 15 (or feed holes) formed in the opposite surface side.

The slit groove part 12 has plural block bodies 11 of a rectangular prism shape. Each block body 11 is arranged in a lattice shape in order to form the plural slit grooves 14. For example, each slit groove 14 has a slit groove width of 140 μm.

After extrusion and mold using the molding die, each penetration cell is formed in a porous structure body through each block body 11 in the molding die 10, and each cell wall is formed in the porous structure body through each slit groove 14.

The circular hole part 13 has the plural circular holes 15. Each circular hole 15 is formed at a part where corners of adjacent block bodies 11 are gathered. Each circular hole 15 communicates with the corresponding slit groove 14. The clayey ceramic raw material is fed into the molding die 10 through the circular holes 15 (or the feed holes), and extruded through the slit grooves 14 in the slit groove part 12.

As shown in FIG. 1C, each block body 11 of the molding die 10 is covered with a coating layer 20 in order to improve its wear resistance capability of the molding die 10. According to the present invention, the coating layer 20 is composed of plural coating layers (or coating sub-layers) 21, 22, and 23, for example. The first coating layer 21 made of TiC is formed directly on the upper end surface of each block body 11. The second coating layer 22 made of TiCN is formed on the first coating layer 21. The third coating layer 23 made of TiN is formed on the second coating layer 22.

Each of the coating layers (or coating sub-layers) 21, 22, and 23 has a thickness of 1 μm, for example and a hardness of 2000 HV. That is, each of the coating layers (or coating sub-layers) 21, 22, and 23 has the hardness which is approximately four times of that of the block bodies 11 in the molding die 10. The presence of the coating layers 21, 22, and 23 increases the wear resistance capability of the molding die 10.

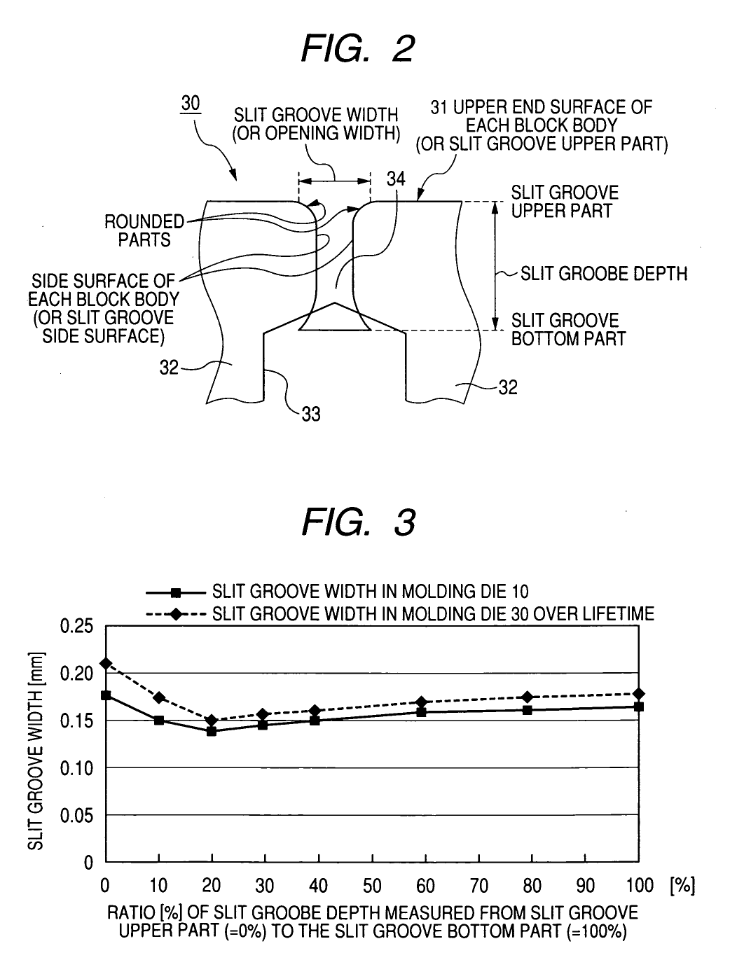

Next, a description will now be given of the method of regenerating the molding die over its lifetime shown in FIG. 2 to FIGS. 4A and 4B.

The regeneration method according to the present invention regenerates a molding dies 30 which have been worn, or deteriorated after repetition use in producing porous structure bodies. That is, the molding die 30 over its lifetime is used as a molding die, but it cannot produce any porous structure bodies which satisfy a predetermined quality standard. The method according to the present invention regenerates the molding die 30 over its lifetime as a target material.

The following description will explain a case of regenerating a molding die not having a remained coating layer, which is over its lifetime after repetition use. However, the method according to the present invention can be applied to a case of regenerating a molding die over its lifetime having a remained coating layer.

A slit groove part 31 in the molding die 30 over its lifetime is grinded or cut in order to obtain a plane surface of the slit groove part 31, namely, to form a flat upper end surface of each block body 11.

FIG. 2 is a cross section of adjacent block bodies 32 in the molding die 30 which is over its lifetime. As shown in FIG. 2, the corner part formed between the side surface and the upper end surface of each block body 32 has a round shape. Such a corner part is rounded by wearing the upper end surfaces of each block body 32 in the molding die 30 after repetition use in feeding clayey ceramic raw material into the circular holes 33, and extruding the compressed clayey ceramic raw material through the slit grooves 34, and finally expanding the extruded one through the upper end surface (or the slit groove part side) of each block body 32.

Thus, the molding die 30 over its lifetime has the slit grooves 34 in which an opening width of each slit groove 34 becomes wide by wearing the upper end part of each block body 32, when compared with that of a new molding die 10.

In the method of the first embodiment, the upper end part of each block body 32 is cut by a predetermined constant thickness in order to eliminate the rounded corner part of each block body 32. This working can decrease the opening width of each slit groove 34 (or the slit groove width). In the method according to the first embodiment, the upper end surface of each block body 32 in the molding die 30 over its lifetime is cut using a grinding machine.

A physical grinding work of the upper end surface of each block body 32 will now be quantitatively explained.

First, two types molding dies are prepared, a new molding die and the molding die 30 over its lifetime.

Each molding die is then cut in order to measure the depth and width of each slit groove in each molding die.

FIG. 3 is a view showing a relationship between the slit groove width (mm) and a ratio (%) of the slit groove depth measured from a slit groove upper part to a slit groove bottom part in two types of molding dies, a new molding die and the molding die 30 over its life time;

In FIG. 3, the horizontal line indicates a ratio (%) of the slit groove depth measured from its upper part (which has the value of 0%) to the slit groove bottom part (which has the value of 100%) in the new molding die and the molding die 30 over its life time. The vertical line in FIG. 3 indicates the slit groove width. That is, a large ratio (%) indicates a large depth of the slit groove 34.

As shown in FIG. 3, both of the new molding die and the molding die 30 over its lifetime have a narrowest slit groove width at the position of the ratio of 20%, and a mostly wider slit groove width at the slit groove upper part of the ratio of zero %. Through the slit groove upper part of the ratio of zero %, the clayey ceramic raw material is extruded.

In a concrete example, the slit groove width at the slit groove upper part in the new molding die is 0.17 mm. On the contrary, the slit groove width at the slit groove upper part in the molding die 30 over its lifetime was 0.18 mm or more.

In general, the thickness of each cell wall in a porous structure body produced using the molding die is determined based on the slit groove width in direction of extruding clayey ceramic raw material from the position at the minimum slit groove width, corresponding the ratio of 20% shown in FIG. 3, in each slit groove.

Cell walls of the porous structure bodies as mold bodies produced using the new molding die and the molding die 30 over its lifetime were measured. The cell wall of the mold body produced using the new molding die is within a range of 0.14 mm to 0.15 mm. On the contrary, the cell wall of the mold body produced using the molding die 30 over its lifetime is 0.18 mm.

This experimental results indicate that the cell wall thickness of the porous structure body produced using the molding die is determined by the slit groove width within the range of 20% measured from the slit groove upper part in the molding die. That is, it is possible to regenerate and reuse the molding die over its lifetime by cutting the end surface of each block body 30 by a maximum 20% depth measured from the slit groove upper part in order to form the flat upper end surface of each block body 30.

However, as shown in FIG. 3, because the slit groove width can be decreased to a half of the slit groove width at the slit groove upper part by cutting the upper end surface of each block body 30 by 20% depth measured from the slit groove upper part, it is possible to regenerate or reuse the molding die by cutting the end surface of each block body 32 by at least 10% depth.

It is therefore preferable to grind or cut the upper end surface of each block body 32 by at least 10% depth, and a maximum 20% depth measured from the slit groove upper part. The reason why the end surface of each block body 32 in the molding die 30 over its lifetime is cut by the maximum 20% depth is that there is a possibility of causing deterioration of a density and shape of each block body 32 made of the clayey ceramic raw material when the depth (or height) of each slit groove 34 is decreased. Still further, there is a possibility of causing the deterioration of the strength of each block body 32 when the slit groove upper part (or the upper end surface of each block body 32) is deeply cut.

It is preferable to cut the upper end surface of each block body 32 by not less than 0.1 mm. It is difficult to regenerate the rounded corner parts of the upper end surfaces of adjacent block bodies 32 into an acute angle corner part when the end surface of each block body 32 is cut by less than 0.1 mm.

After the cutting process, the method according to the first embodiment of the present invention performs a coating process in which the molding die 30 having the flat upper end surface of each block body 32 is coated with a coating layer 20 with chemical vapor deposition method (CVD method).

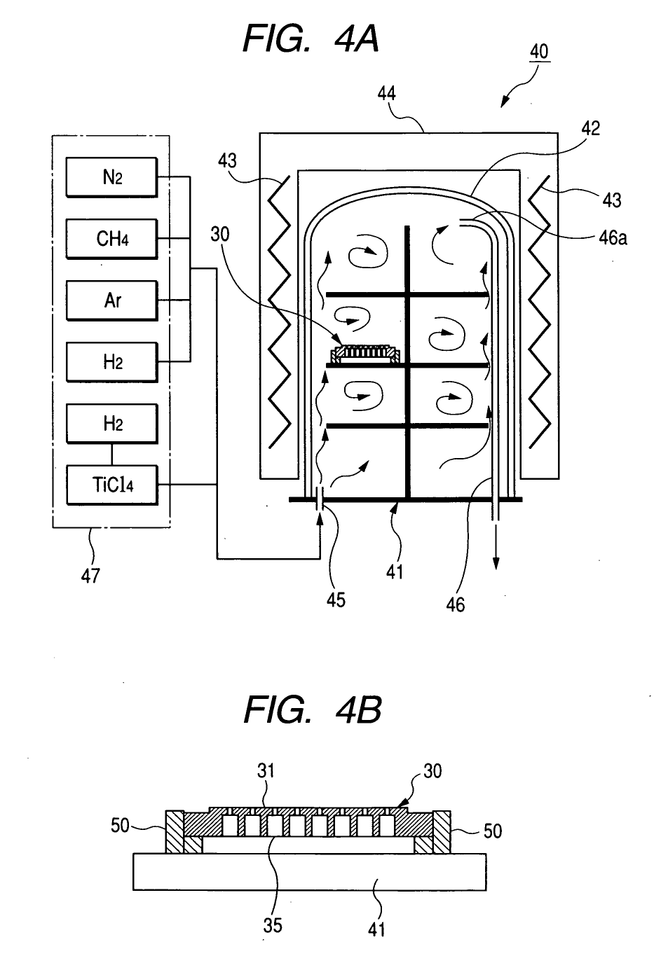

FIG. 4A is a schematic view of a configuration of a CVD apparatus, used in the method according to the first embodiment of the present invention, with which the coating layer 20 is formed on the molding die 30. FIG. 4B is an enlarged view showing the molding die 30 over its lifetime which is placed on a set table 41 in the CVD apparatus 40 shown in FIG. 4A.

As shown in FIG. 4A, the CVD apparatus 40 is comprised of the set table 41 composed of plural shelves, a partition wall part 42, and a reaction chamber 44. Plural molding dies 30 to be regenerated are placed on the shelves in the set table 41. The room formed between the partition wall part 42 and the set table 41, on which the molding dies 30 are placed, is degassed and sealed. The reaction chamber 44 is equipped with a heater 43 therein, and accommodates the partition wall part 42.

In the method according to the first embodiment, the set table 41 has the three stage shelves on which plural molding dies 30 over its lifetime as the targets in regeneration are placed. As shown in FIG. 4A, the CVD apparatus 40 has a process gas supply inlet 45 at the bottom part thereof and an exhaust gas pipe 46 is disposed at the upper part thereof near the uppermost stage shelve in the set table 41.

As shown in FIG. 4B, the molding die 30 over its lifetime is mounted on a setting jig 50. The setting jig 50 is placed on the set table 41 in the partition wall part 42 in the CVD apparatus 40 so that the circular holes 35 in the molding die 30 face the surface of the set table 41. That is, each molding die 30 over its lifetime is so placed on the set table 41 in the CVD apparatus that the slit groove part 31 faces the upper side of the CVD apparatus 40 in order to easily react the slit groove part 31 and reaction gases together. In the first embodiment, a SKD metal plate of a size of 200 mm² and a thickness of 20 mm is used for the molding die 30 over its lifetime as the regeneration target work.

As shown in FIG. 4A, the CVD apparatus 40 is equipped with a process gas tank unit 47 composed of plural reaction gas tanks such as N₂ gas tank, CH₄ gas tank, Ar gas tank, H₂ gas tank, and TiCL₄ gas tank. The gases N₂, CH₄, Ar, H₂, and TiCl₄ contained in those gas tanks are used in forming the coating layer 20 on each block body 32 of the molding die 30.

Each gas tank is joined to the process gas supply inlet 45. Through the process gas supply inlet 45, those gases are supplied into the partition wall part 42 in the CVD apparatus 40.

The CVD apparatus 40 has a dimension of φ450 mm×700 mm. The processing temperature of the CVD apparatus 40 is within a range of 900° C. to 1000° C. A controller (not shown) controls a heating temperature, a heating period of time, a supply amount of each gas to the partition wall part 42.

In the coating layer formation process, the reaction chamber 44 is heated at a temperature within a range of 900° C. to 1000° C. by the heater 43. Titanium and Carbon or Nitrogen are reacted using thermal energy in the reaction chamber 44 heated at a temperature within a range of 900° C. to 1000° C. in order to form the TiC or TiCN film on the slit groove part 31 of the molding die 30.

Before the coating layer forming step, the molding die 30 over its lifetime, whose slit groove part has been flatted by the above cutting step, is washed. The molding die 30 is placed on the set table 41 using the setting jig 50. The set table 41 is then sealed in the partition wall part 42. The reaction chamber 44 is heated at a temperature within a range of 900° C. to 1000° C. by the heater 43. Following, a CVD process is carried out. The method according to the first embodiment forms three coating layers 21 to 23 on the slit groove part 31 of the molding die 30 while the necessary gases are supplied from the process gas unit 47 into the partition wall part 42 through the process gas supply inlet 45.

In the coating forming process, the first coating layer 21, TiC layer is formed on the slit groove part 31 with chemical reaction, TiCl₄+CH₄=TiC+4HCl. Next, the second coating layer 22, TiCN layer is formed on the first coating layer 21 with chemical reaction, TiCl₄+CH₄+(½)N₂=TiCN+4HCl. Finally, the third coating layer 23, TiN layer is formed on the second coating layer 22 with chemical reaction, TiCl₄+(½)N₂=TiN+4HCl.

In the method according to the first embodiment, the thickness of each of the coating layers 21, 22, and 23 is 1 μm, and the hardness thereof is 2000 HV. The formation of the coating layers 21 to 23 on the slit groove part 31 can increase the wear resistance of the molding die 30. It is preferable to have a high hardness when compared with the block bodies 32 as a base material of the molding die. Because the block bodies 32 as the base material of the molding die 30 have a hardness of 500 HV, it is preferable that the hardness of each of the coating layers 21, 22, and 23 is 1.5 times or more of that of the base material. That is, it is preferable that the hardness of each of the coating layers 21, 22, and 23 has not more than 750 HV.

In order to form each uniform coating layer 21, 22, and 23, it is preferable to supply a uniform process gas flow in the partition wall part 42. The regeneration process is completed after the molding die 30 is cooled. That is, the method according to the present invention effectively regenerates the molding die 30 over its lifetime.

The inventor according to the present invention prepared various types of the molding dies, which are regenerated from the molding die 30 over its lifetime, based on the method of the present invention under following conditions (a) and (b), and formed the mold bodies using those molding dies, and measured the thickness of each cell wall of each mold body.

(a) The slit groove part of the molding die 30 was cut by 10% of the slit groove depth; and

(b) The slit groove part of the molding die 30 was cut by 20% of the slit groove depth.

The above experiment results that the thickness of each cell wall of the mold body becomes 0.16 mm using the slit grooves of the molding die regenerated under the those cases (a) and (b), where the thickness of each cell wall of the mold body made using the molding die before regeneration was 0.18 mm. It is possible to produce the mold body using the molding die regenerated by the method according to the first embodiment of the present invention, where each cell wall thickness of this mold body is the same as that of a mold body produced using a new molding die. There are no differences in shape, characteristics (such as isostatics strength), and thermal resistance between those two mold bodies.

The molding die which is made by regenerating the molding die over its lifetime is used for producing monolith mold bodies. That is, clayey ceramic raw material is fed from the circular holes and extruded through the slit grooves in the molding die regenerated in order to produce a monolith mold body (or a porous structure body) while the molding die regenerated is shifted toward the circular hole part 13. The circular holes (or feed holes) are formed in the circular hole part 13 and the slit grooves are formed in the slit groove part 12 in the molding die 10 which has been regenerated from the molding die 30 over its lifetime. In this case, the clayey ceramic raw material is extruded at a pressure of 100 kg/cm², for example. Thus, the molding die 10 regenerated is used in producing such a monolith mold body.

Still further, the molding die 10 was repeatedly used to measure the lifetime thereof. Concretely, the molding die 30 over its lifetime was prepared. In order to make the molding die 10 regenerated, the coating layer 20 of a thickness of not more than 5 μm was formed on the molding die 30 by the method according to the first embodiment described above. Clayey ceramic raw material for cordierite was extruded using the molding die 10 regenerated in order to make a mold body of φ100 mm×90 mm as a porous structure body. The slit groove width of the molding die 10 is 140 μm. The molding die having the slit grooves whose width exceeds 150 μm is categorized in the group of the molding die over its lifetime.

As a result, the molding die 10 regenerated from the molding die 30 has a long lifetime which is approximately three times of that of the molding die without the regeneration treatment. That is, it is possible to extend the lifetime of the molding die by the regeneration treatment described above. This can also decrease the total manufacturing cost of the molding die by approximating ⅓ times.

In the method of regenerating the molding die over its lifetime according to the first embodiment described above, the slit groove part 31 of the molding die 30 over its lifetime becomes firstly flat by cutting or grinding the surface of the slit groove part 31 and the flat surface of the slit groove part 31 is then covered with the coating layer 20.

In particular, cutting or grinding the slit groove part 31 of the molding die 30 can regenerate the slit groove width which is expanded by wearing the block bodies 32 of the molding die after repetition use. In other words, it is possible to decrease the expanded slit groove width to its original width. Further, forming the coating layer 20 on the flat slit groove part can enhance the wear resistance capability of the base material of the molding die. According to the method of the present invention, it is possible to regenerate a molding die over its lifetime, and to use the regenerated one in order to carry out repetition production for porous structure bodies.

### Second Embodiment

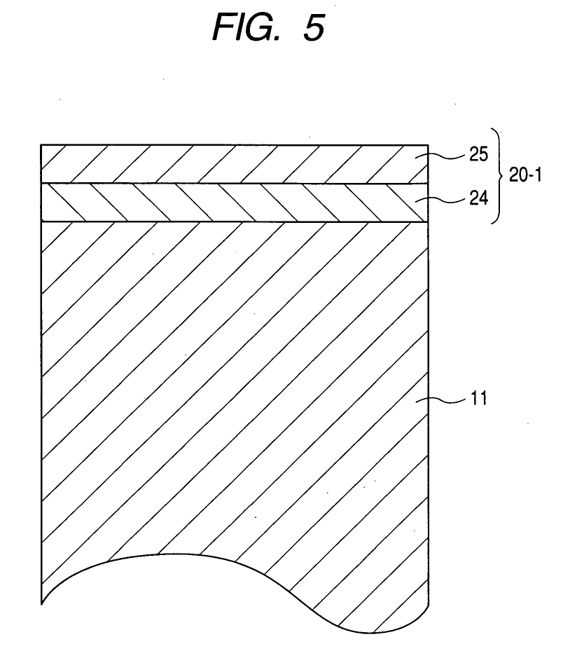

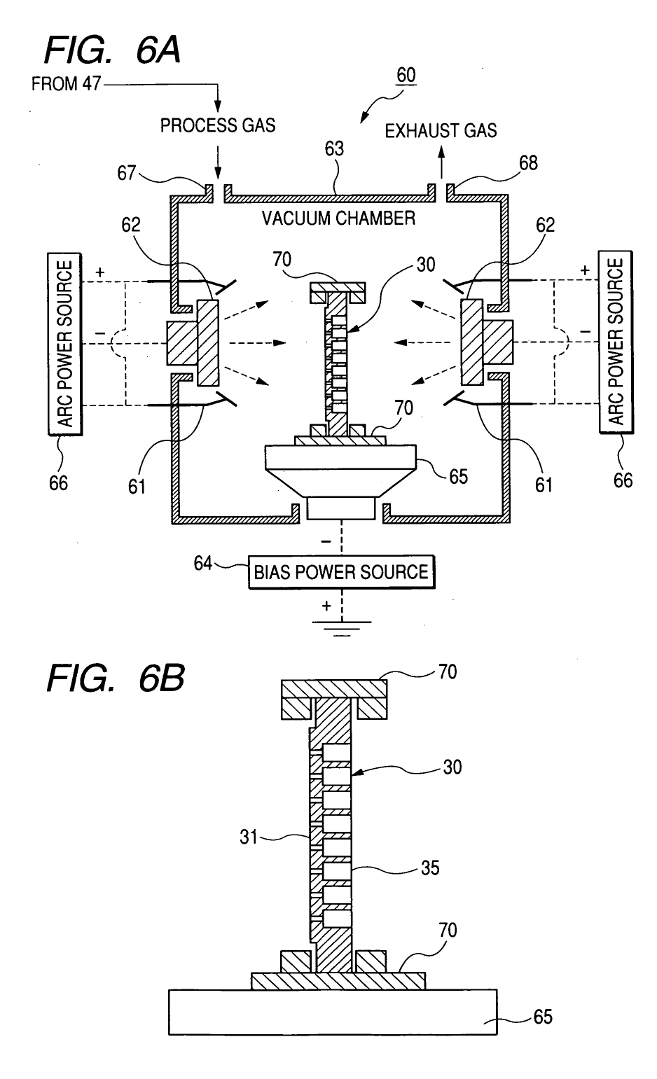

A description will be given of the method of regenerating the molding die over its lifetime according to the second embodiment of the present invention with reference to FIG. 5 to FIGS. 6A and 6B. The difference matters of the second embodiment from the first embodiment will mainly be explained.

FIG. 5 is a cross section of the block body 11 in the molding die regenerated by the method according to the second embodiment of the present invention. The molding die regenerated shown in FIG. 5 is used for producing porous structure bodies, like the first embodiment. The method of the second embodiment forms a first coating layer 24 made of CrN on the upper end surface of each block body 11, and further forms a second coating layer 25 made of TiN on the first coating layer 24, for example.

FIG. 6A is a schematic view of a configuration of a PVD apparatus 60, used by the method according to the second embodiment of the present invention, with which first and second coating layers are formed in each block body of the molding die 30. FIG. 6B is an enlarged view showing the molding die over its lifetime placed on a rotary table 65 in the PVD apparatus 60 shown in FIG. 6A.

As shown in FIG. 6A, the PVD apparatus 60 is comprised of a vacuum chamber 63, the rotary table 65, and a pair of arc power sources 66. Plural anode electrodes 61 and metal targets 62 are disposed in the vacuum chamber 63. A negative voltage of a bias power source 64 is applied to the rotary table 65. The molding die 30 over its lifetime is placed on the rotary table 65. The arc power sources 66 supply a positive voltage to the anode targets 61 and supply a negative voltage to the metal targets 62.

Both of a gas supply inlet 67 and an exhaust gas outlet 68 are formed in the vacuum chamber 63. The gas supply inlet 67 is joined to the process gas tank unit 47 shown in FIG. 4A. As shown in FIG. 6B, the molding die 30 as a regeneration target work is set by a setting jig 70 and placed on the rotary table 65 so that the slit groove part 31 and the circular hole part 35 face the metal targets 62. Like the method of the first embodiment, a SKD metal plate of a size of 200 mm² and a thickness of 20 mm is used for the molding die 30 over its lifetime as the regeneration target work. The rotary table 65 in the PVD apparatus 60 has a diameter of 600 mm and a height of 600 mm, namely, φ600 mm×600 mm.

The inside of the vacuum chamber 63 is evacuated with a vacuum pump (not shown) and heated by a heater (not shown), for example, 1×10⁻⁶ Torr and at 500° C.

The vacuum chamber 63 in the PVD apparatus 60 is heated until 500° C., and Ti and Cr ions are absorbed on the slit groove part 31 of the molding die 30 in the vacuum chamber 63, where Ti and Cr atoms are ionized using Nitrogen gas as a process gas. That is, after performing the pre-treatment, like the method of the first embodiment, the molding die 30 is set with the setting jig 70 and placed on the rotary table 65 in the vacuum chamber 63. Following, the inside of the vacuum chamber 63 is evacuated, and heated. In order to perform a uniform PVD reaction, the rotary table 65 on which the molding die 30 is mounted rotates.

Following, arc discharge is carried out in the vacuum chamber 63, where the metal targets 62 are the negative electrode using the arc power sources 66. The arc discharging makes an arc spot on the surface of the metal targets 62 and the arc spot runs on the metal targets 62. A part of the metal targets 62 is instantly evaporated by arc current energy of 70 A to 200 A concentrated at the arc spot, and the evaporated one becomes metal ions and fly in the inside of the vacuum chamber 63.

On the other hand, the metal ions in the vacuum chamber 63 are accelerated by applying the negative bias voltage to the molding die 30 through the rotary table 65. The metal ions and reaction gas particles are closely adhered on the slit groove part 31 of the molding die 30. In this case, the metal targets 62 are replaced with another kind of the metal targets in order to form the coating layers 24 and 25 on the slit groove part 31 of the molding die 30 in the required order.

First, Cr ions are emitted using Cr metal targets into a Nitrogen atmosphere in the vacuum chamber 63 and a CrN layer as the first coating layer 24 is formed on the slit groove part 31 of the molding die 30. Following, Ti ions are emitted using Ti metal targets into the Nitrogen atmosphere in the vacuum chamber 63 and a TiN layer as the second coating layer 25 is formed on the first coating layer 24 on the slit groove part 31 of the molding die 30. In the method of the second embodiment, each of the first and second coating layers has a thickness within a range of 10 μm to 20 μm, and a hardness of 2000 HV.

Since the rotary table 65 turns during the coating layer formation process, the metal ions such as Cr and Ti ions are also adhered on other parts, for example, on the circular holes 35, in addition to the slit groove part 31. This is not a serious problem because the coating layer 20-1 composed of the first and second coating layers 24 and 25 can be formed on at least the slit groove part 31 of the molding die 30.

The regeneration process for the molding die 30 is completed after the molding die 30 is cooled. As shown in FIG. 1A and FIG. 1B, the molding die 10 is thereby made.

The inventor according to the present invention prepared the molding die 10 having the coating layers 24 and 25 which were regenerated by the method using the molding die 30 over its lifetime under the following conditions (a) and (b), produces porous structure bodies (or mold bodies) using the molding die 10 regenerated, and measured the thickness of each cell wall of each produced mold body.

(a) The slit groove part of the molding die 30 was cut by 10% of the slit groove depth; and

(b) The slit groove part of the molding die 30 was cut by 20% of the slit groove depth.

The experimental results in thickness of each cell wall in the mold body in the second embodiment are same as those of the first embodiment. Further, the molding dies 10 were repeatedly used to measure the lifetime thereof.

In a concrete example, the molding die 30 over its lifetime was prepared. In order to make the molding die 10, the coating layer 20-1 of a thickness of at least not less than 1 μm was formed on the slit groove part 31 of the molding die 30 by the method according to the second embodiment. Clayey ceramic raw material for cordierite was extruded using the molding die 10 regenerated in order to make a mold body such as a porous structure body of φ100 mm×90 mm as the porous structure body. The slit groove width of the molding die 10 is 140 μm. The molding die having the slit grooves whose width exceeds 150 μm is categorized in the group of the molding die over its lifetime.

As a result, the molding die 10 regenerated from the molding die 30 using the PVD apparatus 60 has a long lifetime which is approximately two times of that of the molding die without the regeneration treatment.

The coating layer 20-1 formed using the PVD apparatus 60 is relatively separated from the slit groove part 31 because metal ions are spattered on the slit groove part 31 of the molding die 30 when compared with the case using the CVD apparatus 40 of the first embodiment.

Therefore although the lifetime of the molding die regenerated by the method of the second embodiment using the PVD apparatus is slightly lower than that of the molding die regenerated by the method of the first embodiment using the CVD apparatus, it is possible to extend the lifetime of the molding die approximating two times by the regeneration treatment of the method of the second embodiment when compared with the molding die without performing any regeneration treatment.

As described above, it is possible to extend the lifetime of the molding die even if the coating layer part 20-1 is formed on the slit groove part 31 using the PVD apparatus 60 in the regeneration method of the second embodiment described above.

### Third Embodiment

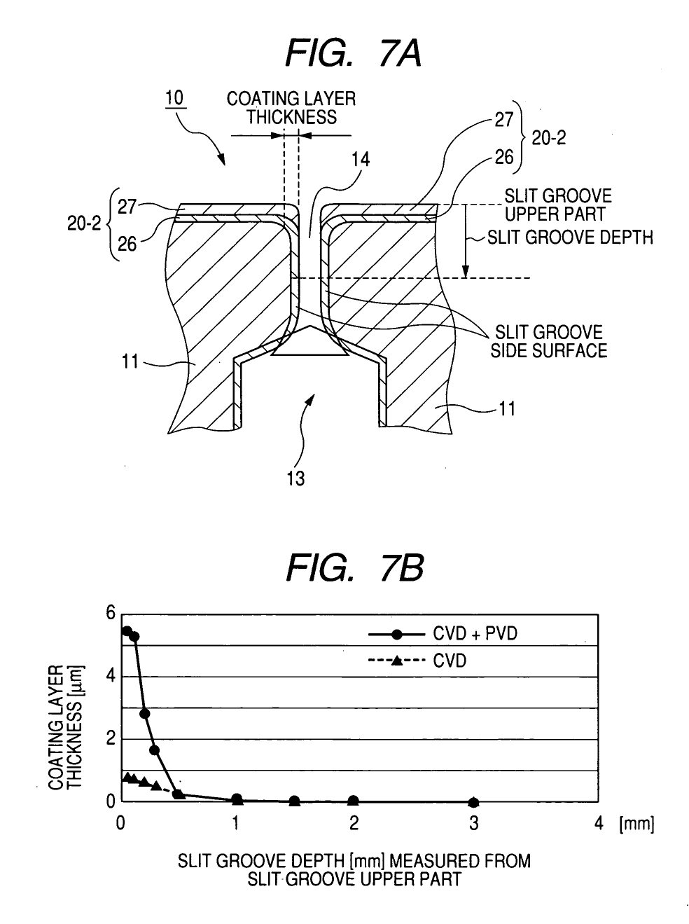

A description will be given of the method of regenerating a molding die which is over its lifetime according to the third embodiment of the present invention with reference to FIGS. 7A and 7B to FIG. 9.

The difference matters of the third embodiment from the first and second embodiments will mainly be explained.

Although the method of the second embodiment forms the coating layer 20-1 on the slit groove part 31 of the molding die 30 using the PVD apparatus, this manner involves a possibility of separating the coating layer 20-1 from the upper end surface, namely, from the slit groove part 31, of each block body of the molding die 30 during the use of the molding die 10 for producing mold bodies. However, because the TiN layer formed using the PVD apparatus has a hardness of 2500 HV, for example, which is not less than three times of the base material forming the molding die 10, the formation of the coating layer 20-1 using the PVD apparatus can contribute to the expansion of the lifetime of the molding die.

It is therefore possible to extend the lifetime of the molding die using a combination of CVD method and PVD method in view of the features, where the CVD method can form the coating layer tightly adhered on the slit groove part (or the upper end surface of each block body) in the molding die 30 and the PVD method can form the coating layer of a high hardness.

That is, a coating layer is firstly formed on the slit groove part 31 of the molding die 30 using the CVD apparatus 40, and another coating layer is then formed on the coating layer formed on the slit groove part 31 using the PVD apparatus 60 in order to improve the hardness of the coating layer 20-1 shown in FIG. 5.

The method according to the third embodiment of the present invention forms the coating layer using a combination of CVD method and PVD method. The method of the third embodiment uses the CVD apparatus 40 in the first embodiment and the PVD apparatus 60 in the second embodiment. Other devices and the coating layer formation conditions are the same as those of the first and second embodiments.

At a first stage, a first coating layer 26 of a thickness within a range of 1 μm to 3 μm is formed on the slit groove part 31 (or the upper end surface of each block) in the molding die 30 using the CVD apparatus 40. Because the first coating layer 26 formed using the CVD apparatus 40 is used as a base layer, it is preferable to form it as thinner as possible, for example, not more than 5 μm.

In a second stage, a second coating layer 27 of a thickness of not less than 1 μm is formed on the first coating layer 26 on the slit groove part 31 of the molding die 30 using the PVD apparatus 60. The second coating layer 27 acts as a ware protection layer. The molding die 10 shown in FIG. 1A and FIG. 1B is thereby produced.

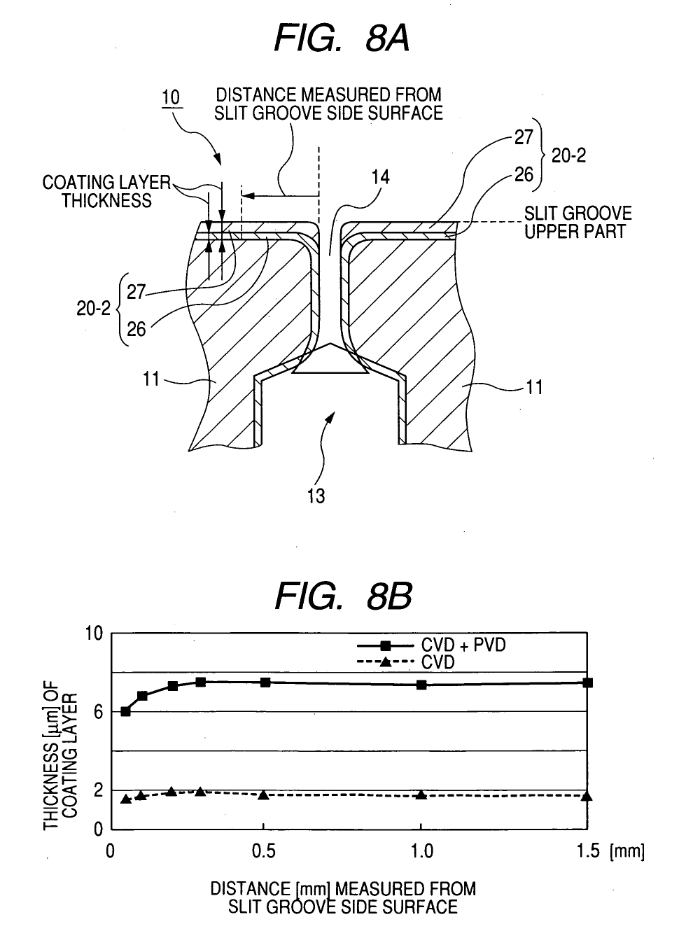

The inventor compared the coating layer formed on the molding die only using the CVD apparatus 40, and the coating layer formed on the molding die, composed of the first coating layer 26 formed using the CVD apparatus 40 and the second coating layer 27 formed using the PVD apparatus 60. FIGS. 7A and 7B and FIGS. 8A and 8B show those comparison results.

FIG. 7A is an explanatory view of defining a coating layer thickness measured from a slit groove side surface and of defining a slit groove depth measured from a slit groove upper part of the molding die. FIG. 7B is a comparison result of different treatments (CVD and CVD+PVD) in a relationship between the coating layer thickness and the slit groove depth in the molding die.

As shown in FIG. 7A, the slit groove depth is defined as a distance or length measured from the slit groove upper part toward the circular hole 13 communicated with the slit groove 14. The thinner the slit groove depth, the more the slit groove upper part (or upper surface) approaches to the upper part of the circular hole 13. The thickness of the coating layer 20-2 is defined as a thickness measured from the side surface of each block body 11 to the surface of the coating layer 20-2, as shown in FIG. 7A. The coating layer 20-2 is composed of the coating layer 26 formed using the CVD apparatus 40 and the coating layer 27 formed using the CVD apparatus 40 and the PVD apparatus 60.

The relationship between the thicknesses of the coating layer and the slit groove depth was measured. As a result, as shown in FIG. 7B, the first coating layer 26 as a base coating layer formed using the CVD apparatus 40 has a thickest value at the slit groove upper part, which is approximately not more than 1 μm at the most. On the other hand, the coating layer 20-2 composed of the coating layers 26 and 27 is thicker than the coating layer 26. Thus, it is possible to form the thicker coating layer 20-2 at the slit groove upper part, namely, at the opening edge of each clit groove 14 through which clayey ceramic raw material is extruded.

FIG. 8A is an explanatory view of defining a coating layer thickness measured from the upper end surface of the block body and of defining a distance measured from a slit groove side surface in the molding die 30. FIG. 8B is a comparison result of different treatments (CVD and CVD+PVD) in a relationship between the coating layer thickness and the distance measured from the slit groove side surface shown in FIG. 8A.

As shown in FIG. 8A, the distance measured from the slit groove side surface is a distance measured from a side surface of the coating layer formed on the slit groove side surface, in other words, on the side surface of the block body 11, toward the opposite surface of the block body 11. Increasing the distance measured from the slit groove side surface approaches toward the middle point of the surface of the block body 11. The coating layer thickness is a thickness measured from the slit groove upper part (or surface), namely, from the upper end surface of the block body 11.

The coating layer thickness to the above distance was measured As a result, as shown in FIG. 8B, both of the coating layers, formed using the CVD apparatus 40, and using the CVD apparatus 40 and the PVD apparatus 60, the coating layer thickness is increased according to the increase of the distance measured from the slit groove side surface, and saturated, in other words, both of the coating layer 26 and a multi-coating layer composed of the coating layers 26 and 27 became an uniform layer. Accordingly, it is possible to certainly form a uniform coating layer on the slit groove upper part (namely, on the surface of the bock body 11), even if using a combination of the CVD method and the PVD method.

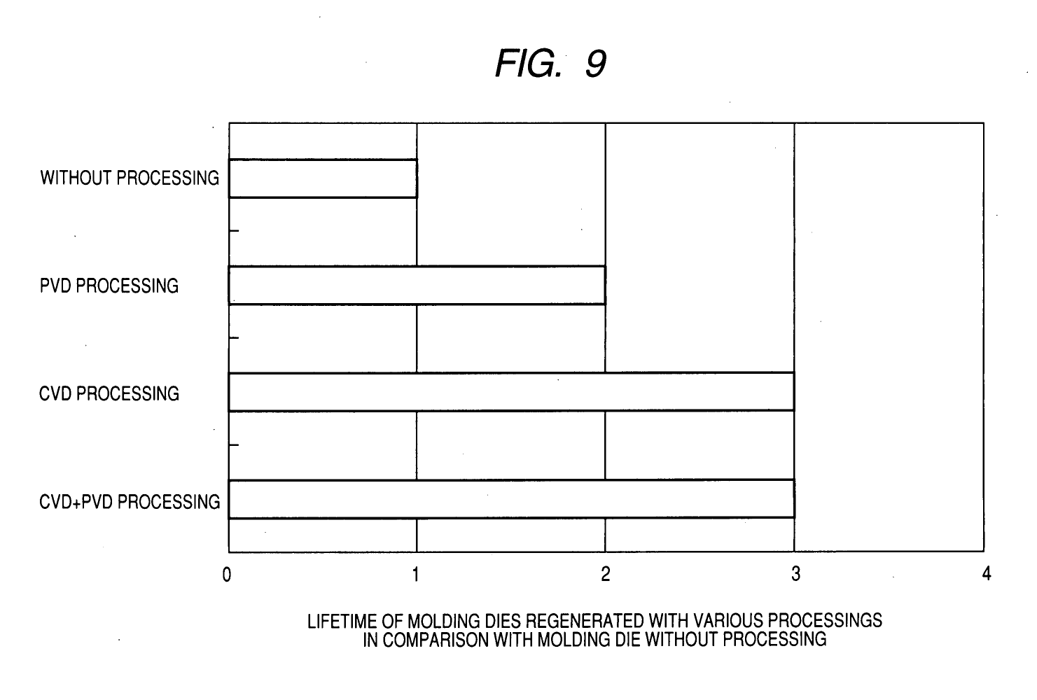

The method of the third embodiment can regenerated the molding die 30 over its lifetime, like the methods according to the first and second embodiments. The molding die 10 was repetitively used in order to measure its lifetime. In a concrete example, the molding die 30 over its lifetime was regenerated by the following steps. The coating layer 26 of not more than 3 μm composed of TiC layer and TiCN layer are formed on the molding die 30 over its lifetime using the CVD apparatus 40, and the coating layer 27 of not less than 1 μm composed of TiN layer was then formed on the coating layer 26 using the PVD apparatus 60, like the method described above. Clayey ceramic raw material for cordierite was extruded using the molding die 10 regenerated in order to make a mold body such as a porous structure body of φ100 mm×90 mm as the porous structure body. As a result, the molding die 10 regenerated from the molding die 30 has a long lifetime which is approximately three times of that of the molding die without the regeneration treatment. The lifetime measuring results are shown in FIG. 9.

FIG. 9 is a comparison result in lifetime of various types of molding dies, the molding die not processed, the molding die processed using PVD method, the molding die processed using CVD method, and the molding die processed using a combination of CVD and PVD methods.

As shown in FIG. 9, each of the molding die having the coating layer 20 formed using the CVD apparatus 40 according to the first embodiment, and the molding die having the coating layer 20-2 formed using both the CVD apparatus 40 and the PVD apparatus 60 according to the third embodiment has a lifetime of three times when compared with that of the molding die without processing. Further, the molding die having the coating layer 20-1 formed using both the PVD apparatus 60 according to the second embodiment has a lifetime of two times when compared with that of the molding die without processing. The method of regenerating a molding die according to the present invention can extend the lifetime of the molding die and decrease the total molding die manufacturing cost.

As described above in detail, it is possible to form the coating layer on the molding die using a combination of CVD method and PVD method. The method of regenerating a molding die according to the third embodiment has a superior capability of forming the coating layer 27 of an extremely high hardness on the slit groove part of the molding die.

### (Other Modifications)

In the methods of regenerating the molding die over its lifetime according to the first to third embodiments, the upper end surface of each block body (or the slit groove part) is cut or grinded, and one or more coating layers are then formed on the flat-shaped upper end surface of each block body (or on the flat shaped slit groove part) in the molding die 30. The present invention is not limited by the above methods. For example, it is possible to only cut or grind the upper end surface of each block body (or the slit groove part) in the molding die without forming any coating layer on the flat-shaped upper end surface or slit groove part in order to repair the opening width of each slit groove to its original slit groove width which is equal to that of a new molding die before repetition use. It is accordingly possible to extend the lifetime of the molding die only by cutting the upper end surface of each block body (or the slit groove part). This case enables one or more coating layers to be formed on the upper end surface of each block body after the cutting process, in order to further extend the lifetime of the molding die.

In each method according to the first to third embodiments described above, because the circular hole part of the molding die 30 is not held or supported by any jig when the coating layer is formed on the upper end surface of each block body (or the slit groove part 31), the circular hole part 31 is also coated with the same coating layer. That is, there is a possibility of escaping the reaction gas from the slit groove part to the circular hole part through the inside of the slit grooves 34. Because it is better to uniformly flow the reaction gas onto the slit groove part, it is possible to place a masking plate on the circular hole part 13 in the molding die 30 in order to have an uniform flow of the reaction gas on the slit groove part.

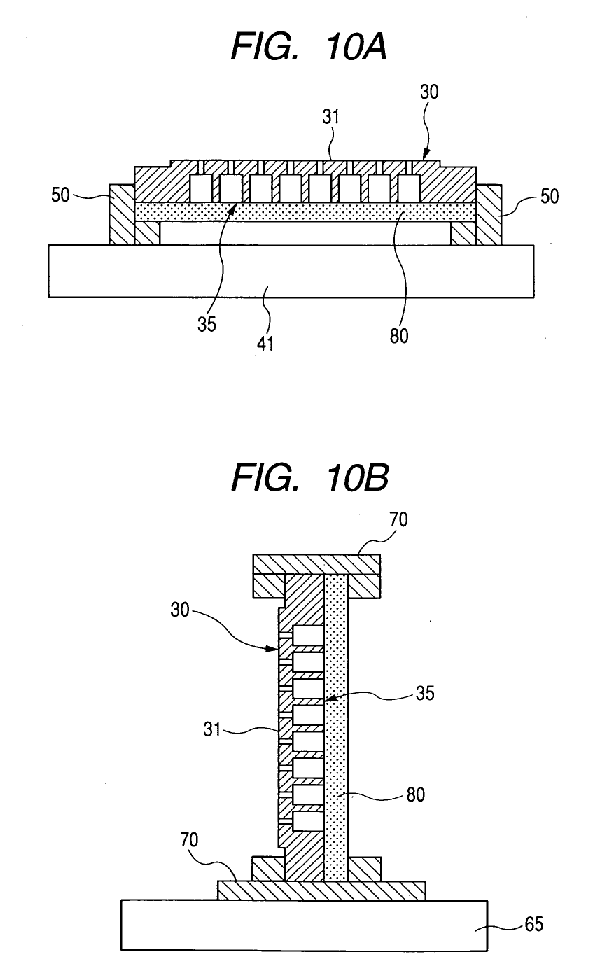

FIG. 10A is a view showing the molding die 30 over its lifetime, having the circular holes (or feed holes) covered with such a masking plate 80, placed on the setting jig 50 on the set table 41 in the CVD apparatus 40. FIG. 10B is a view showing the molding die 30 over its lifetime, having the circular holes covered with the masking plate 80, placed on the setting jig 70 on the rotary table 65 in the PVD apparatus 60. For example, the masking plate 80 is made of graphite. As shown in FIG. 10A, the molding die 30 is so placed in the CVD apparatus 40 that the masking plate 80, facing the setting table 41, is set onto the circular hole part, and the slit groove part 31 faces the ceiling part of the CVD apparatus 40 in order to easily contact and react the slit groove part 32 with reaction gases.

In addition, as shown in FIG. 10B, the circular hole part is covered with the masking plate 80 in the PVD apparatus. This configuration enables the masking plate 80 to prevent the adhesion of metal ions emitted from the metal targets 62 on the circular hole part. That is, no ion is adhered on the circular hole part of the molding die 30.

As described above, the lifetime of the molding die having the coating layer can be extended even if the molding die is regenerated using the masking plate 80. It is thus possible to form the uniform coating layer on the slit groove part under uniform flow of the reaction gas, in which the masking plate 80 prevents the reaction gas flowing between the slit grooves and the circular hole. This configuration can further prevent the formation of the coating layer on the side surface of the block body 32.

Although each embodiment of the present invention has explained the use of the molding die having the block bodies of a rectangular shape, it is possible to use a molding die having a plurality of block bodies of a hexagonal shape, namely, having a plurality of slit grooves arranged in a honeycomb structure shape. Clayey ceramic raw material is extruded through the slit groove part in the molding die having the slit grooves arranged in such a honeycomb structure shape. In this case, a mold body extruded has a plurality of cells arranged in a honeycomb structure shape. It is thus possible to use a molding die having various shapes of the block body.

Further, each embodiment of the present invention uses JIS (Japanese Industrial standard) SKD metal plate forming the base material of the molding die. It is also possible to use another type of metal such as iron-based material, SUS (Stainless Used Steel) based material, and super hard alloy based material. Still further, each embodiment of the present invention forms the coating layer composed of plural layers. It is possible to prevent wearing the upper end surface of each block body when at least a coating layer is formed on the upper end surface of each block body. It is therefore acceptable to form a single coating layer on the upper end surface (or the slit groove part) in the molding die.

Still further, although each embodiment cuts or grinds the surface of the upper end surface of each block body (or the slit groove part) in the molding die 30 over its lifetime, it is possible to have a flat shaped upper end surface of each block body in the molding die using other processes such as an electric discharge method (EDM), and an acid treatment method instead of the cutting or grinding step.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A method of regenerating a molding die, which is over its lifetime, for use in producing porous structure bodies, wherein the molding die comprising: a circular hole part composed of plural circular holes, formed in one surface side of the molding die, through which clayey raw material is fed into the molding die; and a slit groove part composed of plural slit grooves, formed in the other surface side of the molding die, communicate with the circular holes, and plural block bodies divided by the slit grooves,
the method of regenerating the molding die over its lifetime comprising cutting an upper end surface of each block body by a predetermined constant depth.

2. The method of regenerating a molding die over its lifetime according to claim 1, wherein the upper end surface of each block body is cut by at least one of a grinding method, an electric discharge method, and an acid treatment method.

3. The method of regenerating a molding die over its lifetime according to claim 1, wherein the predetermined constant depth is within a range from at least not less than 0.1 mm to not more than 10% of a slit groove depth, wherein the slit groove depth is defined as a value measured from the upper end surface of each block body to a joint part at which the slit groove communicates with the corresponding circular hole.

4. The method of regenerating a molding die over its lifetime according to claim 2, wherein the predetermined constant depth is within a range from at least not less than 0.1 mm to not more than 10% of a slit groove depth, wherein the slit groove depth is defined as a value measured from the upper end surface of each block body to a joint part at which the slit groove communicates with the corresponding circular hole.

5. The method of regenerating a molding die over its lifetime according to claim 1, further comprising a step of forming a coating layer on at least the upper end surface of each block body after completion of the cutting step, wherein the coating layer is harder than the block bodies.

6. The method of regenerating a molding die over its lifetime according to claim 2, further comprising a step of forming a coating layer on at least the upper end surface of each block body after completion of the cutting step, wherein the coating layer is harder than the block bodies.

7. The method of regenerating a molding die over its lifetime according to claim 3, further comprising a step of forming a coating layer on at least the upper end surface of each block body after completion of the cutting step, wherein the coating layer is harder than the block bodies.

8. The method of regenerating a molding die over its lifetime according to claim 5, wherein during the coating layer forming step, the circular hole part is covered with a masking plate in order to form the coating layer only on the upper end surface of each block body.

9. The method of regenerating a molding die over its lifetime according to claim 6, wherein during the coating layer forming step, the circular hole part is covered with a masking plate in order to form the coating layer only on the upper end surface of each block body.

10. The method of regenerating a molding die over its lifetime according to claim 7, wherein during the coating layer forming step, the circular hole part is covered with a masking plate in order to form the coating layer only on the upper end surface of each block body.

11. The method of regenerating a molding die over its lifetime according to claim 5, wherein the coating layer is composed of a plurality of coating layers.

12. The method of regenerating a molding die over its lifetime according to claim 8, wherein the coating layer is composed of a plurality of coating layers.

13. The method of regenerating a molding die over its lifetime according to claim 1, wherein when the molding die over its lifetime, as a target of the regeneration, has the coating layer formed on the slit groove part, the cutting step cuts the remained coating layer in addition to the upper end surface of each block body.

14. The method of regenerating a molding die over its lifetime according to claim 1, wherein the coating layer is formed using one of CVD method and a combination of CVD method and PVD method.
